(19) United States
(12) Patent Application Publication
(10) Pub. No.: US 2023/0382248 A1
(43) Pub. Date: Nov. 30, 2023

(54) MONETIZABLE, INTERACTIVE, FLAT ELECTRIC VEHICLE MOBILE CHARGER CABLE

(71) Applicant: David Albert Sirieix, New York, NY (US)

(72) Inventor: David Albert Sirieix, New York, NY (US)

(21) Appl. No.: 18/326,620

(22) Filed: May 31, 2023

Related U.S. Application Data
(60) Provisional application No. 63/347,249, filed on May 31, 2022.

(51) Int. Cl. B60L 53/18; B60L 53/16; B60L 53/30; B60L 53/66; H01B 7/08

(52) U.S. Cl. CPC B60L 53/18; B60L 53/16; B60L 53/305; B60L 53/66; H01B 7/08; B60L 53/122

(57) ABSTRACT

A charging cable includes a cover encompassing one or more electrically conductive cables having a first end and a second end; a first coupler that couples the first end to a vehicle charging port; a second coupler that couples the second end to the external power supply; and a control device mounted to the electrically conductive cables. The control device includes a data storage component that stores a usage history; a detection component that detects the vehicle charge level and updates the usage history; and a user interface. A method of electric vehicle charging includes providing a smartphone application electronically connected to the control device; detecting a charge level of the electric vehicle; storing a usage history based on the detected charge level; charging the electric vehicle; and collecting payment by the smartphone application.

### CROSS-REFERENCE TO RELATED APPLICATION

This application claims the benefit of priority of U.S. provisional application Ser. No. 63/347,249, filed May 31, 2022, the contents of which are herein incorporated by reference.

### BACKGROUND OF THE INVENTION

The present invention relates to electric vehicle charging devices and, more particularly, to a monetizable, interactive, flat electric vehicle mobile charger cable.

In order to charge, electric vehicles (EV) need a cable run from the car to a charging point—in a private garage, a public garage, or an outdoor space—that may cause humans to trip. Many valuable city and suburb locations are prevented from becoming EV charging stations (CS) as EV users cannot lay out their electronic vehicle charging system (EVCS) mobile connector, wall charger, or wireless charger without creating a hazard. A regular cable charger is not flat, covered, nor safe at all.

A traditional EV mobile cable connector, wall or wireless, cannot be used conveniently in a public setting or even at a home, as they may represent a physical hazard. Currently available devices are not safe for pedestrians, may be cumbersome to set up, are not portable, and do not roll for convenient storage. They do not offer built-in managed monetization for a host to charge for use of their electricity. Therefore, they do not allow most ground public locations to become a private or a public charging location.

Moreover, scooters and e-bikes do not have access to many of the existing charging locations.

The first solutions are curb charging stations, which are expensive to install and require a sidewalk opening. They can only be installed on selected locations of which there are insufficient numbers. Additionally, if they are located on a facade and not on the curb, the cable can hardly cross the sidewalk. Some curb charging stations have created an overhead charging arm (sometimes referred to as “potences”) that raise the cable over a perch and eliminate the risk of a trip hazard but that only work for curb charging stations that do not cross a sidewalk.

English locals have suggested digging a small trench and inserting a metal gully to run a regular cable from the street to the house or a business facade. They are not removable and will tenderize the public sidewalk and make it fragile.

As can be seen, there is a need for a portable EV charger that does not pose a trip hazard and enables monetization of its use.

### SUMMARY OF THE INVENTION

In one aspect of the present invention, a charging cable through which an electric vehicle is charged from an external power supply comprises one or more electrically conductive cables having a first end and a second end; a cover encompassing the one or more internal electrically conductive cables; a first coupler that couples the first end to a vehicle charging port; a second coupler that couples the second end to the external power supply; and a control device mounted to the one or more electrically conductive cables, wherein the control device includes: a data storage component that stores a usage history of the charging cable; and a detection component that detects a charge level of the electric vehicle and that updates the usage history based on the detected charge level; and a user interface.

In another aspect of the present invention, a method of charging an electric vehicle with the charging cable comprises providing a smartphone application electronically coupled to the control device; detecting a charge level of the electric vehicle by the control device; storing a usage history based on the detected charge level by the control device; charging the electric vehicle; and collecting payment for charging the electric vehicle by the smartphone application.

The EVCS mobile connector (MC) disclosed herein combines a safe, convenient, ergonomically designed cable cover and a monetized interactive EVCS MC, wall charger, or wireless charger. Businesses, commercial buildings, or private hosts locations can now become charging locations as the EVCS mobile structure is a simple system to install and convenient to remove.

The EVCS mobile smart connector provides a flat cord or cable surface and connects the wall or the wireless charger of any EV vehicle and monetizes the electricity used, anywhere—in the city, over a sidewalk with city approval, in a private alley, in a commercial or a private garage, or at home, safely without interrupting pedestrian or vehicle traffic and without causing trip hazards. It may be used as a tool to solve major cities' charging issues by allowing and making many more charging locations available to charge cars. A user in a public space may park and charge the car anywhere near an existing outlet from a host business or private location for a small convenience fee paid to the host. They do not need to park and charge from the street (they can park against a wall) while cars and motorbikes park on the street.

These and other features, aspects and advantages of the present invention will become better understood with reference to the following drawings, description, and claims.

### BRIEF DESCRIPTION OF THE DRAWINGS

FIG. 1 is a perspective view of a flat charging cable according to an embodiment of the present invention;

FIG. 2 is a perspective view of a flat charging cable according to another embodiment of the present invention;

FIG. 3 is side perspective view of a flat charging cable according to another embodiment thereof;

FIG. 4 is a detail side view thereof;

FIG. 5 is a perspective view a flat charging cable according to another embodiment of the present invention;

FIG. 6 is a perspective view a flat charging cable according to another embodiment of the present invention;

FIG. 7 is a perspective view a flat charging cable according to another embodiment of the present invention;

FIG. 8 is a perspective view a flat charging cable according to another embodiment of the present invention;

FIG. 9 is a perspective view a flat charging cable according to another embodiment of the present invention;

FIG. 10 is a side view a flat charging cable according to another embodiment of the present invention;

FIG. 11 is a perspective view a flat charging cable according to another embodiment of the present invention, shown in use; and

FIG. 12 is a detail view, shown in rotation.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The terms “mobile” and “portable” are used interchangeably herein.

Broadly, one embodiment of the present invention is a monetizable, interactive EV mobile connector, wall, or wireless charger with a built-in flat, rollable, portable, protective, covered cable.

The flat charger cable of the present disclosure is sometimes called “Ghost” herein.

The Ghost smart cord or cable connector has a first of its kind, generally flat supply cable (e.g., up to about 2 or 2.5 cm thick, preferably up to 2 cm, such as up to 1.2 cm, and about 8-10 cm wide, in some cases up to about 12 cm wide), eliminating trip hazards and allowing strollers, wheelchairs, buggies, UPS®, FedEx®, and Amazon® carts to roll over the cord.

The interactive EVCS mobile connector with a built-in protective, ergonomic, rollable, portable, and storable cover encapsulates and flattens a mobile connector/wall charger/wireless ground charger cable, allowing traffic to pass over, enabling hosts at valuable private and public locations with high traffic the potential to monetize the electricity from an external power supply, becoming EVCS mobile, wall, or wireless charging locations. The EVCS mobile interactive wall charger with rollable, portable, protective cable cover and payment system may be configured for home or public use. The cable may be used with a wall charger or a WI-FI®/wireless charger. Wireless charging tiles placed under the car may utilize the inventive smart flat cord or cable with a coupler having an outlet/electrical socket connection on one end, a printed circuit board (PCB) with Booster, and a coupler coupled to the wireless tile on the other end. The EVCS mobile interactive connector may be used with a Tesla® super-charger and any type of stationary curb charging equipment.

The inventive charging system comprises a safe, portable, mobile charger cable and an interactive monetized transformer/booster mobile connector, wall charger or WI-FI® charger. It is easy to install and can be used to exploit low tech charging stations, including in areas not accessible before, anywhere around the world.

The mobile charger with portable protective cover may be configured for use with any EVs, including cars, trucks, or recreational vehicles (RVs) scooters, e-bikes, and e-motorbikes. The built-in protective cover cable could be used by EV manufacturers that make an EVCS Mobile charger or wall charger cord, allowing the user to charge anywhere conveniently, easily, and safely without the burden of a complicated installation or of protecting the ground connection. Any private or commercial use that requires a ground cable to be safe and flat, rollable if needed and/or to be protected from traffic for convenience, safety, or appearance may benefit from the inventive system.

The cable with built-in rollable, portable, protective cable cover may be any suitable length, such as about 6 feet up to about 20 feet long. For example, the EVCS cable with a transformer, a PCB, and a booster may be 20 feet long. In some cases, the cable may be about 10 feet long. The cover may accommodate one or more internal electrically conductive cables. The internal cable(s) may have a round cross-section within the flat cover.

The EVCS mobile connector cable may include a transformer and booster. An integrated booster accelerates the charge of a level 1 or 2 charger to make it even more attractive for fast charge requirements. The smart connector may be, for example, a level 2 charger with built in booster.

The rollable flat cord or cable may have a coupler at a first end that connects flat onto a J1772 handle that connects to the vehicle charging port and a coupler at a second end that connects flat to a printed circuit board (PCB), transformer, and booster. In some embodiments, the cable may have a J1772 connector on both ends. Alternatively, the first end may connect to a wireless induction charging tile.

A set of adapters may be provided to plug the cord into different types of sockets (i.e., Level 1 at 110V-120V or level 2 at 220V, 5-20 kilowatts [KW], or Tesla adapters). The cable may also be coupled to a direct current [DC] (fast charger, e.g., 40-350 KW) portable battery pack system which may be associated with a taller cable profile in some cases.

In some embodiments, the system may have a magnetic locking system. For example, the adapters may have a lock selected from the group consisting of a magnetic lock, a mechanical lock, and a combination thereof.

The EVCS MC combines a safe, convenient, ergonomically designed cable cover and a monetized interactive EVCS mobile connector, wall charger, or a wireless charger. The EVCS MC may be used with a network of HOSTS: private and public locations (like hotels, restaurants, public garages, private garages, or alleys) who agree to lend or dedicate EV parking for the mobile, wall or wireless charging system without further complex underground or wall installation. The private host or a commercial host is incentivized to participate as the host gets compensated.

The host of a location may monetize the service as the portable, rollable smart connector may interact with an App via a PCB board to act as a removable curb charging station. The host can monetize his or her locations by receiving a payment from the EV charge user via the Ghost built in application. The App and the built-in software enable the host to monetize the charge of any amenities using a public space regardless of whether safe traffic is required. The phone Application may interact with a controller such as the EVCS PCB/microprocessor, transformer, and booster to log in/out, geolocate, and make payment for the charge. The PCB may also have an interactive display screen. The phone Application may be used to scan the EVCS screen quick response (QR) code to connect/disconnect, start/end the charge, and make a payment. It can also scan an independent QR code located on the location outlet or equipment source (wall charger, wall, or outlet). The phone application may interact via WI-FI® and/or Bluetooth® and allow short message exchange with the host during the charge. In some embodiments, an App is provided to modify an existing mobile connector, a home wall charger, or a WI-FI® charger to interact for a payment system. The portable mobile connector may also be used without the app by simply connecting and charging the homeowner or host utility account.

In some embodiments, the system may have an interactive device located on the cable, incorporating a PCB, transformer and a small screen, to monetize the cable through a short message service (SMS) exchange with the hosts directly. A microprocessor with a screen may be operative to store and display charging data including a QR code for payment, to start, and to end a charging session.

The inventive cord and/or cover may be manufactured of a high-density polyethylene (HDPE) and may have a rubber rib.

The smart connector can be laid out ‘anywhere’ in a city where a connection would normally be difficult or hazardous, e.g., over a sidewalk or in a garage. A home user may layout the EVCS simply, quickly, and safely in his own garage, e.g., between 2 cars, without worrying about his kids tripping over the EV charging cable. The smart connector can be applied to all electric vehicle types including boda bodas and tuk-tuks, as well as any other electric amenities or accessories, indoor or outdoor, that use a heavy-duty cable running across a room, like on a movie set or in the music concert industry, where pedestrian traffic or vehicle traffic safety is a concern. For example, the film industry studio may use the built-in cable cover for outdoor or indoor sets. The cable may also be used for electric amenities, such as outdoor grills, electric condenser heating, ventilation, and air conditioning (HVAC) systems, requiring a floor electric cable connection where pedestrian or vehicle traffic is expected.

The inventive device or system may be used with a home/outdoor wall charger and/or with a wireless charger. The system may be newly installed, it may replace existing portable cords or cables currently used in EV cars, or it may retrofit an existing regular round cable system. The inventive system may also be applied to an EV WI-FI® charging street platform system with a payment system, especially as they get smaller and more portable.

To use the inventive cord, an EV driver may use the smartphone application map to geolocate the closest or most convenient host charging locations (which may be public or private spaces) using the EVCS global positioning system (GPS); the Application also permits a short message service (SMS) exchange with the Host. The EV driver parks the EV at a selected location they select from the App. The host or the EV driver lays out the EVCS booster cable with the built in flat, rollable, portable cord/cable with protective cover on the ground between the EV and the host outlet. The host or the EV driver connects the EVCS Mobile connector plug to the outlet using an adapter, if necessary, and plugs the J1772 handle into the EV. The adapter is locked with magnetic force during the charge to prevent someone from stealing it. Note the J1772 can use a Society of Automotive Engineers (SAE) J1772 charging Tesla car adapter and use the outlet adapter provided for the wall outlet. The EV driver may turn on and off the EVCS manually (switch) or launch it interactively with the Phone App Bluetooth® function. The EV driver scans a QR code displayed on the EVCS screen to start or prepay the charge (which may include a convenience fee). The control device has a detection component that detects a charge level based on a control signal exchanged between the charging cable and the electric vehicle and a data storage component operative to store a usage history of the charger and any transactions made. Once the charge is completed, the EVCS disconnects or the user can end the charge by re-scanning the EVCS device. The host or the EV driver unplugs and rolls the EVCS with its rollable protective cable cover and returns it to the storage location, which may be back in the EVE or at the host location.

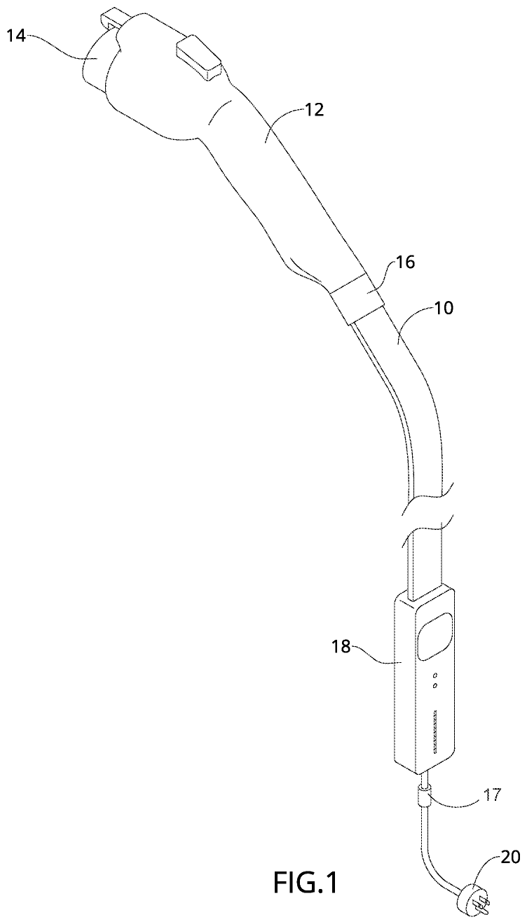

Referring to FIGS. 1 through 8, FIG. 1 shows a mobile charging device according to an embodiment of the present invention includes a flat charging cable 10, having a J1772 handle 12 with a charging plug 14 coupled to a first end and an electrical plug 20 coupled to an opposite second end, which may have a quick switch connector 17. A rotation element 16 rotatably joins the handle 12 to the cable 10, as illustrated in FIG. 12. A control device 18 including a transformer, a booster, a PCB, and a user interface screen is joined to the cable 10 proximate to the electric plug 20.

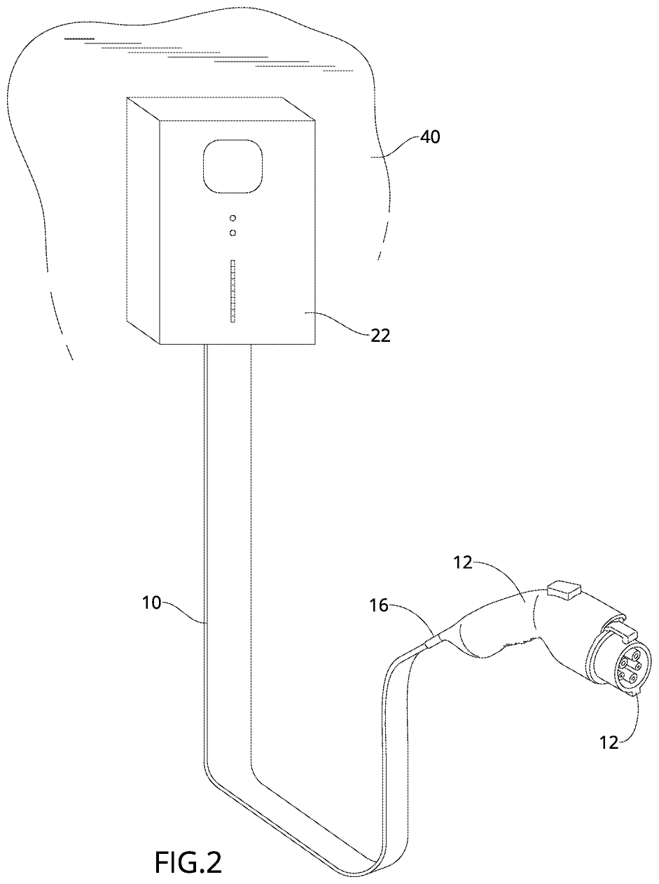

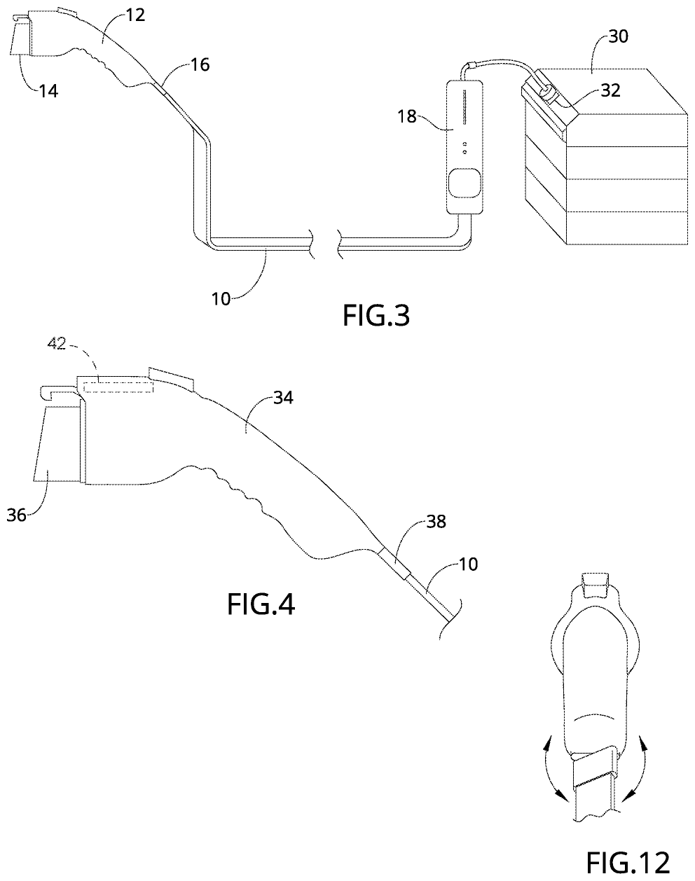

As shown in FIG. 2, the electrical plug 20 may be replaced with a wall-charger 22 mounted to a wall 40. FIG. 3 illustrates an alternative embodiment in which the electrical plug 20 may be replaced with a portable battery 30 with connector 32.

FIG. 4 illustrates an alternative embodiment of the handle 34 with a charging plug 36 and a PCB 42 embedded adjacent to the plug 36. A tapered flat end 38 joins the handle 34 to the cable 10. In some embodiments, the charging plug 36 may be a proprietary wall plug and socket housing a sub meter 42 that connects to the grid separately from the main house electric meter.

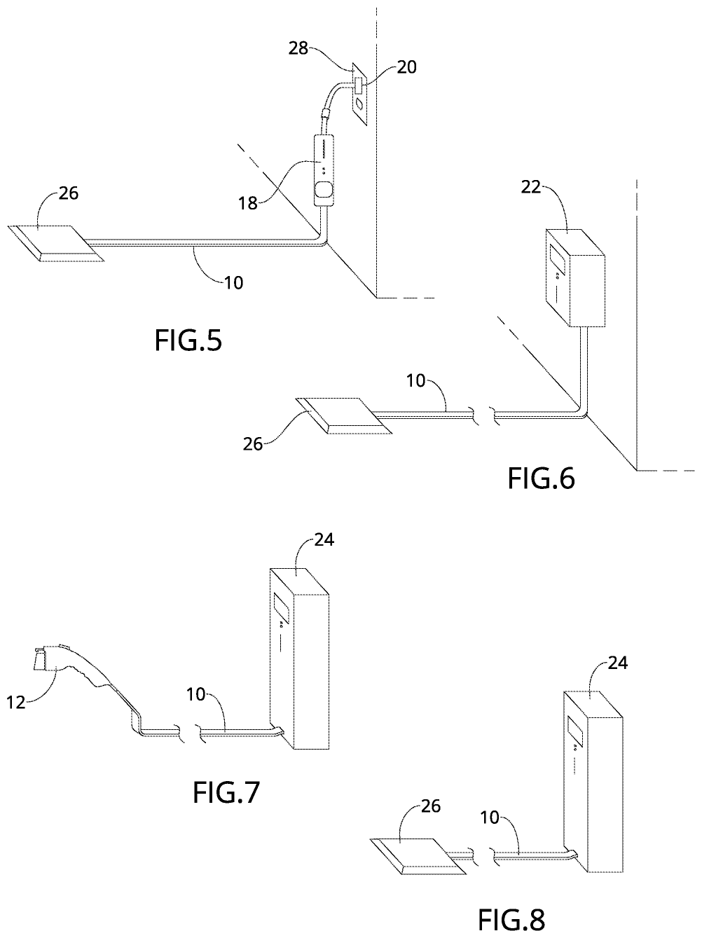

As shown in FIGS. 5, 6, and 8, the handle 12 and charging plug 14 may be replaced with a wireless pad/tile charger 26. FIG. 5 illustrates use of the mobile charging device with the electrical plug 20 positioned within a wall outlet 28. As shown in FIG. 6, the mobile charging device may be used with a wall mounted home charger 22 e.g., a Level 2 charger. FIGS. 7 and 8 illustrate use of the mobile charging device with a curb charger 24.

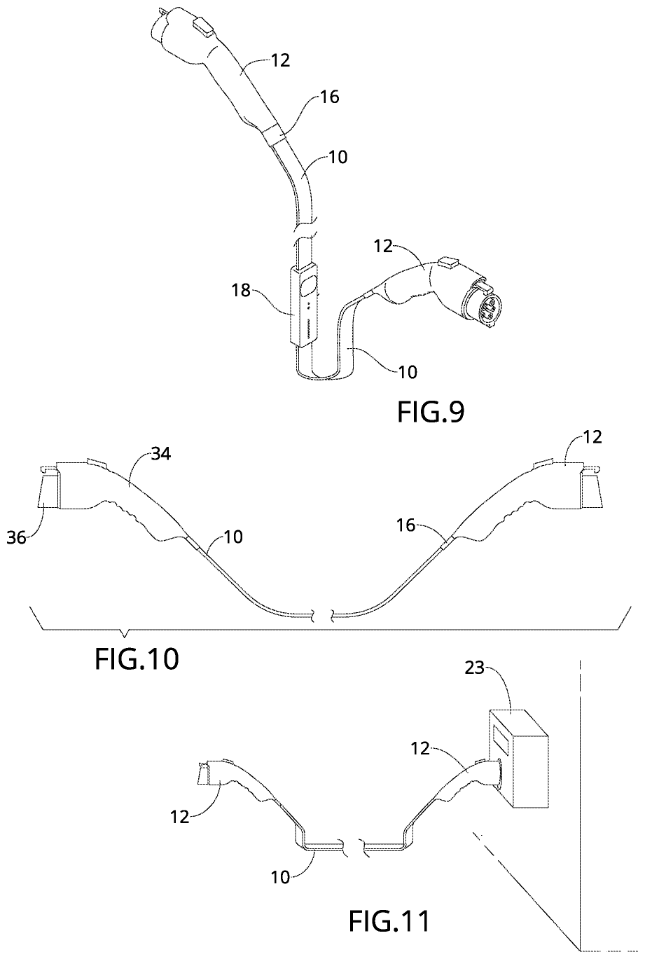

FIGS. 9 through 11 illustrate embodiments having a charging handle 12 coupled to each end of the cable 10 by way of a rotation element 16. As shown in FIG. 10, one of the handles 34 may contain a PCB. One handle 12 may be plugged into a wall charger with outlet 23, as shown in FIG. 11.

It should be understood, of course, that the foregoing relates to exemplary embodiments of the invention and that modifications may be made without departing from the spirit and scope of the invention as set forth in the following claims.

What is claimed is:

1. A charging cable through which an electric vehicle is charged from an external power supply, the charging cable comprising:
one or more electrically conductive cables having a first end and a second end;
a cover encompassing the one or more internal electrically conductive cables;
a first coupler that couples the first end to a vehicle charging port;
a second coupler that couples the second end to the external power supply; and
a control device mounted to the one or more electrically conductive cables, wherein the control device includes: a data storage component that stores a usage history of the charging cable; and a detection component that detects a charge level of the electric vehicle and that updates the usage history based on the detected charge level; and a user interface.

2. The charging cable of claim 1, characterized by a thickness of up to about 2.5 cm, a width of up to about 12 cm, and a length of up to about 20 feet.

3. The charging cable of claim 1, wherein the user interface is electrically connected to a transformer, a PCB, and a booster.

4. The charging cable of claim 1, wherein the electrically conductive cable(s) have a round cross-section.

5. The charging cable of claim 1, wherein the first coupler is joined to a J1772 connector.

6. The charging cable of claim 1, wherein the first coupler is joined to a wireless induction charging tile.

7. The charging cable of claim 1, wherein the second coupler is joined to a J1772 connector.

8. The charging cable of claim 1, wherein the second coupler is couplable to the external power supply via a device selected from the group consisting of a wall charger; a curb charging station; and a portable battery pack system.

9. The charging cable of claim 1, wherein at least one of the first coupler and the second coupler is rotatably joined to the charging cable.

10. The charging cable of claim 1, further comprising at least one adapter couplable to the second coupler and insertable into an electrical socket.

11. The charging cable of claim 1, wherein at least one of the first coupler and the second coupler has a lock selected from the group consisting of a magnetic lock, a mechanical lock, and a combination thereof.

12. The charging cable of claim 1, wherein the cover is formed of a high-density polyethylene (HDPE).

13. The charging cable of claim 1, further comprising a microprocessor operative to store and return charging data, the microprocessor having a display screen operative to display a QR code.

14. A method of charging an electric vehicle with the charging cable of claim 1, comprising:
providing a smartphone application electronically coupled to the control device;
detecting a charge level of the electric vehicle by the control device;
storing a usage history based on the detected charge level by the control device;
charging the electric vehicle; and
collecting payment for charging the electric vehicle by the smartphone application.

15. The method of claim 14, further comprising turning on the charging cable manually or by scanning a quick response (QR) code with the smartphone application.

16. The method of claim 15, further comprising disconnecting automatically once charging is complete or ending the charging by re-scanning the QR code.

17. The method of claim 14, further comprising forming a network of charging hosts.

18. The method of claim 17, further comprising delivering the payment to one of the network of charging hosts via the smartphone application.
